(19) United States
(12) Patent Application Publication
(10) Pub. No.: US 2006/0012630 A1
(43) Pub. Date: Jan. 19, 2006

(54) Ink jet recording apparatus

(75) Inventor: Yukihiro Niekawa, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA MEDICAL & GRAPHIC, INC

(21) Appl. No.: 11/175,279

(22) Filed: Jul. 7, 2005

(30) Foreign Application Priority Data
Jul. 13, 2004 (JP) JP2004-205969

(51) Int. Cl. B41J 23/00

(52) U.S. Cl. 347/37

(57) ABSTRACT

An ink jet recording apparatus provided with recording heads 4 that eject light hardening type ink on to the recording medium P, a light source 5 that emits light on to said light hardening type ink ejected onto said recording medium P, and a carriage 3 in which are mounted said recording heads 4 and said light source 5 and which is configured so as to be able to carry out reciprocating movement along the main scanning direction, with said ink jet recording apparatus having the feature that it is provided with a control section 13 that carries out control so that the carriage movement operation is made at a speed higher than a predetermined lower limit speed at the time when a illumination region of light emitted from said light source 5 is above said recording medium P.

This application is based on Japanese Patent Application No. 2004-205969 filed on Jul. 13, 2004, in Japanese Patent office, the entire content of which is hereby incorporated by reference.

### TECHNICAL FIELD

The present invention relates to ink jet recording apparatuses, and particularly to serial type ink jet recording apparatuses that use optical hardening type inks and also are provided with a light source in the carriage.

### BACKGROUND

Conventionally, image recording apparatuses adopting the ink jet method (ink jet recording apparatuses) have been known as image recording means that record images easily and at low cost, and such ink jet recording apparatuses have been used in various fields.

Further, in the field of recording images on products or on the packaging of products among the fields in which ink jet recording apparatuses are used, very often it is necessary to record images on recording media made of materials with low ink absorption ability such as metal or plastics on such products or packaging materials of products. In order to fix the ink on such recording media optical hardening type of inks that get hardened by polymerization when a light beam of a specific wavelength is emitted in the ink jet recording apparatus are used and the ink ejected onto the recording medium is hardened and fixed by irradiation with a light beam.

Among ink jet recording apparatuses using such a light hardening ink, the serial type ink jet recording apparatus is known (Patent Document 1) that is provided with a carriage on which are mounted a recording head with nozzles formed in it for ejecting the ink and light sources on both sides of the recording head for emitting light towards the ink ejected by the nozzles, and guide rails supporting the carriage, and in which the carriage can carry out reciprocating motion along the main scanning direction. The operation of the carriage during image recording in a serial type ink jet recording apparatus is not only the operation of ejecting the ink from the nozzles while moving at a constant speed but also the accelerating, decelerating, and stopping movements of the carriage during its return movement.

However, in such an ink jet recording apparatus, since the carriage is made to move along the guide rails and since the returning movements are made at the two ends of the guide rail, there was the problem that the scanning time of the carriage becomes long thereby reducing the productivity. In order to avoid this problem, conventionally, at the time of acquiring the image data from an external input device such as a personal computer, etc., the region (image recording region X) in which the actual recording is to be made in the recording medium was calculated, and the movement of the carriage was controlled according to the image recording region X, and in Patent Document 2, as is shown in FIG. 6, the range of carriage movement M was determined in accordance with the image recording region X, and the carriage 3 was being moved by a region equal to the sum of the image recording region X, the region T in which the carriage does the returning movement, and the spare region R. Here, the spare region R is, within the region of illuminated by the light beam spreading in an outward direction from the light source 1, a region considering the region illuminated by the light beam beyond the positions opposite to the light source emission window on the recording medium. Therefore, by adding the spare region R to the carriage movement region M, the situations in which the region of illumination of the recording medium P is wider than the light emission window of the light source 1 can also be taken care of.
Patent Document 1: Japanese Patent Application Laid Open No. 60-132767
Patent Document 2: Japanese Patent Application Laid Open No. 2003-127347

However, the returning operation of the carriage 3 is being done above the area of the recording medium in which no image is actually recorded, and is shown in FIG. 7, the speed of movement of the carriage at the time it moves above the recording medium P is below the lower limit of speed at which the recording medium is not affected by the light source. As a result, the time period of the light source 1 staying above the recording medium P becomes long in the region of the recording medium in which the image is not recorded compared to the region X of the recording medium in which an image is recorded, and hence the recording medium P was getting extended or getting shrunk by receiving heat from the light source 1 thus causing its warping and also the recording medium P would get degraded depending on the constitution of the illuminating light.

In view of this, the present invention has made considering the above points and the purpose of the present invention is to provide an ink jet recording apparatus with which it is possible to obtain high definition recorded images with the bad effect of the light from the light source on the recording medium being eliminated without lowering the productivity.

### SUMMARY

In an ink jet recording apparatus comprising a recording head that ejects light hardening type ink on the recording medium, a light source that emits light on to said light hardening type ink ejected onto said recording medium, and a carriage in which are mounted said recording head and said light source and which is configured so as to be able to carry out reciprocating movement along the main scanning direction, said ink jet recording apparatus has the feature that it is provided with a control section that carries out control so that the carriage movement operation is made at a speed higher than a predetermined lower limit speed at the time when a illumination region of light emitted from said light source is above said recording medium.

### BRIEF DESCRIPTION OF THE DRAWINGS

Embodiments will now be described, by way of example only, with reference to the accompanying drawings which are meant to be exemplary, not limiting, and wherein like elements numbered alike in several Figures, in which:

FIG. 1 is an outline plan view diagram of the ink jet recording apparatus applying the present invention.

FIG. 2 is a control configuration diagram of an ink jet recording apparatus according to the present invention.

FIG. 3 is a side cross-sectional view diagram of the carriage in FIG. 1.

FIG. 4 is an explanatory diagram showing the range of movement of the carriage of an ink jet recording apparatus according to the present invention.

FIG. 5 is an explanatory diagram showing the correspondence between the movement speed of the carriage and the carriage position in an ink jet recording apparatus according to the present invention.

FIG. 6 is an explanatory diagram showing the range of movement of the carriage in an ink jet recording apparatus according to the present invention.

FIG. 7 is an explanatory diagram showing the correspondence between the movement speed of the carriage and the carriage position in the ink jet recording apparatus of FIG. 6.

### DESCRIPTION OF THE PREFERRED EMBODIMENT

By making a control section carry out control of the operation of carriage movement at a speed higher than a predetermined lower limit speed, it is possible to make the carriage move at a speed higher than the lower limit of speed at the time the carriage is moving above the recording medium.

Because of this configuration, since the carriage will not move at a speed lower than the lower limit speed at the time of moving over the recording medium, it is possible to make sure that there is no effect of the light source or the light beam on the recording medium other than that necessary for hardening and fixing the ink on the recording medium. In addition, it is possible to eliminate bad effects of the light source or the light beam on the recording medium.

Furthermore, when the carriage is moved at the lower limit speed, it is possible to emit the maximum quantity of light that does not have bad effects on the recording medium and to harden and fix the ink on the recording medium definitely thereby enhancing the image quality. As a consequence, even when a recording medium with poor ink absorption ability is used, it is possible to obtain recorded images with a high resolution.

Further, by providing an illumination range storage section that stores said illumination range, and by making said control section control the movement range of said carriage based on said illumination range stored in said illumination range storage section, it is possible to carry out control so that the carriage return operation is not made in the state in which the illumination range of the light emitted from the said light source is above the recording medium.

In other words, it is possible to make certain that the recording medium is definitely not exposed to the light beam at the time the carriage is making the return operation and to obtain high definition recorded images while eliminating the bad effects of the light from the light source on the recording medium.

Additionally, according to the present invention, it is possible to prevent the recording medium from being exposed to light at the time of carrying out the return operation of the carriage while suppressing the range of movement of the carriage. Therefore, it is possible to prevent the recording medium P from getting extended, shrunk, warped, or from getting degraded due to the heat or the composition of the light from the light source 1. In addition, since it is possible to prevent warping of the recording medium, it is possible to prevent degradation of the recording medium due to jamming or variation in the distance of transportation of the recording medium without affecting the transportation of the recording medium.

In addition, by providing the lower limit speed storage section that stores the lower limit of the speed of said illumination range moving over the recording medium, and by making said control section carry out control of the operation of carriage movement at a speed higher than said lower limit speed stored in said lower limit speed storage section, it is possible to make the carriage move at a speed higher than the lower limit of speed at the time the carriage is moving above the recording medium.

Further, if said control section sets the lower limit speed according to the type of said recording medium, it is possible to set the lower limit speed of movement of said illumination range over the recording medium in accordance with the type of the recording medium.

In addition, since it is possible to set the lower limit speed of movement of said illumination range over the recording medium in accordance with the type of the recording medium, it is possible to eliminate bad effects of the light source or the light beam on the recording medium in accordance with the type of recording medium.

Further, when ultraviolet rays are used as the light beam emitted from said light source and ink that hardens upon exposure to ultraviolet rays is used, it is possible to harden the ink ejected on to the recording medium by irradiating with ultraviolet rays. For example, it is possible to harden the ink even in the case of a non-absorbing recording medium such as a plastic film, and thus it is possible to harden the ink irrespective of the type of the recording medium.

Further, when said light hardening type of ink is a cation polymerization type of ultraviolet ray hardening ink, since its sensitivity to ultraviolet rays is higher compared to radical polymerization type inks and since the obstruction to the polymerization reaction caused by oxygen is small, it is possible to reduce the illumination intensity necessary for hardening the ink ejected onto the recording medium.

As a consequence, it is possible to harden the ink appropriately even at low illumination intensities irrespective of the type of the recording medium, it is possible to obtain recorded images with the high resolution.

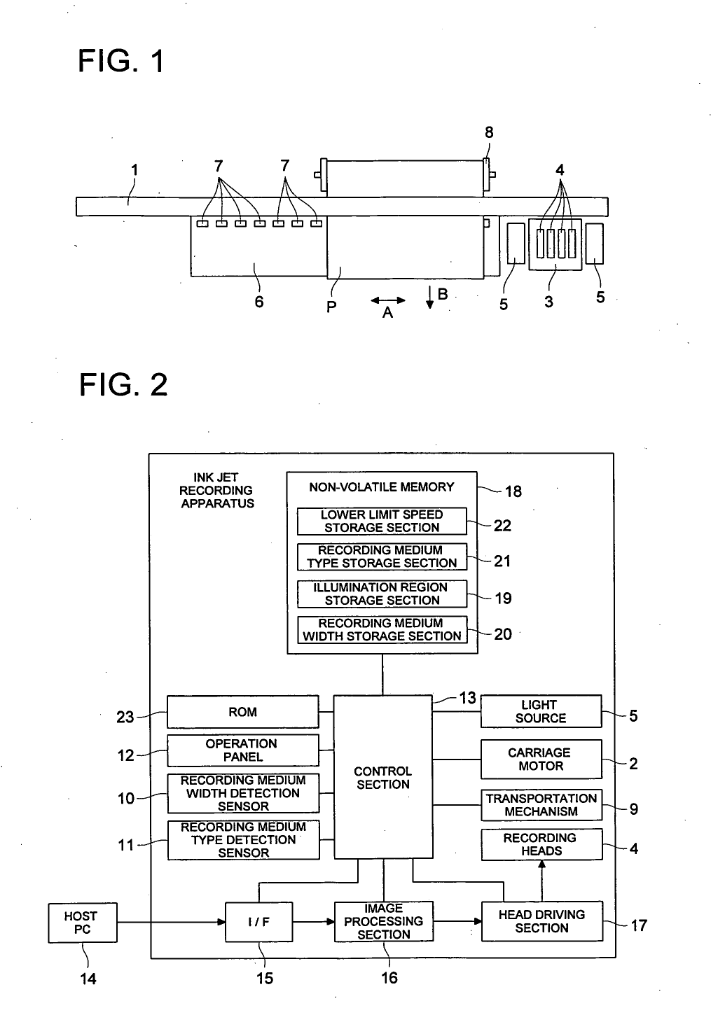

A concrete preferred embodiment of the present invention is described in the following by referring to FIG. 1 to FIG. 5. However, FIG. 1 to FIG. 5 show only an example of the preferred embodiments of the present invention and the scope of the present invention shall not be construed to be restricted to the example shown in these figures. Therefore, it goes without saying that various modifications can be added without exceeding the intent and scope of the present invention.

As is shown in FIG. 1, a rod-shaped guide rail 1 is provided in the interior of the inkjet recording apparatus according to the present invention. The configuration is such that the carriage 3 driven by the carriage motor 2 (see FIG. 2) is supported by the guide rail 1, and the carriage 3 can carry out reciprocating motion along the main scanning direction A along the guide rail 1. Further, a linear encoder, not shown in the figure, is provided in the guide rail 1 and the configuration of the carriage 3 is such that the current position of the carriage 3 can be detected by the linear encoder.

A plurality of recording heads 4, 4, 4, and 4 for each of the colors of yellow (Y), magenta (M), cyan (C), and black (K) are provided in the carriage 3, and a plurality of nozzles, not shown in the figure, for ejecting the ink are arranged along the longitudinal direction of the recording heads 4 on the surfaces of the recording heads 4 that are opposite to the recording surface (the top surface) of the recording medium P.

Further, light sources 4 are provided on the two sides of the recording heads 4 of the carriage 3 along the main scanning direction A, and the light hardening type of ink that has landed on the recording medium P is hardened and fixed by illuminating it with the light beam from the light source 5. In addition, the light beam emitted from the light source 5 in the present preferred embodiment is ultraviolet light, and although it is possible to use as the light source for emitting ultraviolet rays, for example, a low pressure mercury lamp, a high pressure mercury lamp, a metal halide lamp, a hot cathode fluorescent tube, a cold cathode tube an excimer lamp, or an ultraviolet ray laser or LED (Light Emitting Diode), etc., the present invention is particularly suitable for application in the case of a heat generating light source such as a high pressure mercury lamp, etc.

Further, a flat plate shaped platen 6 is provided in the region of carrying out recording on the recording medium within the region of movement of the carriage 3 so that it supports the recording medium P from the side of its non-recording surface.

A transportation roller 7 that is driven by a transportation motor, not shown in the figure, is provided on the upstream side in the auxiliary scanning detection B that is a direction at right angles to the main scanning direction A of the platen 6.

Further on the upstream side along the auxiliary scanning detection B of the transportation roller 7 and the platen 6 is provided a recording medium feed roller 8 on which is wound the long strip-shaped recording medium P. The recording medium feed roller 8 is configured so that not only that it is free to rotate around its axis but also one of its ends can be moved freely to match with the width of the recording medium P. In the present preferred embodiment, the transportation mechanism 9 (see FIG. 2) is configured to comprise the transportation motor and the transportation roller 7, the platen 6, and the recording medium feed roller, and this mechanism transports the recording medium P intermittently along the auxiliary scanning direction B.

A recording medium width detection sensor 10 (see FIG. 2) is provided in the recording medium feed roller 8, and it is possible to detect the width of the recording medium P along the main scanning direction A by measuring the distance along the width direction by which the end of the feed roller 8 can move to suit the width of the recording medium P.

Further, the recording medium feed roller 8 is provided with a recording medium weight detection sensor 11 (see FIG. 2), whereby it is possible to detect the type of the recording medium P. It is possible to use as the recording medium weight detection sensor 11, a device that detects the type of the recording medium by emitting, for example, infrared rays, etc., towards the recording medium and by measuring the percentage of light reflected by the recording medium or by measuring the time taken for it to return after being reflected by said recording medium.

Further, the recording medium width detection sensor 10 and the recording medium weight detection sensor 11 used in the present preferred embodiment need not be restricted to the sensors mentioned above. Also, even the location of their installation can be other than the recording medium feed roller 8, and these sensors can also be provided in the carriage 3. These can be anything as long as they are configured to detect the width and the time of the recording medium P.

In addition, an operation panel 12 (see FIG. 2) is provided in the ink jet recording apparatus so that the user can manually input the type of the recording medium P corresponding to the types of recording media registered beforehand.

Next, the control configuration in this preferred embodiment is described in detail here.

As is shown in FIG. 2, the ink jet recording apparatus is provided with a control section 13 that is configured using a CPU, etc.

The control section 13 is connected to an image processing section 16 that carries out image processing based on the image data input via the interface (I/F) 15 from a host computer 14 such as a PC connected externally.

In addition, the light source 5, the carriage motor 2, the transportation mechanism 9, and the head drive section 17 driving the recording head 4 are connected to the control section 13 which controls the operations of the different members based on the image data. Also, the recording medium width detection sensor 10, the recording medium weight detection sensor 10, the operation panel 12, and the linear encoder are connected to the control section 13 which stores in the non-volatile memory 18 to be described later various types of set values computed based on the data detected by the recording medium width detection sensor 10, the recording medium weight detection sensor 10, the operation panel 12, and the linear encoder.

The non-volatile memory 18 is connected externally to the control section 13, stores various types of set values set by the control section 13, and outputs signals to the control section 13 as and when needed.

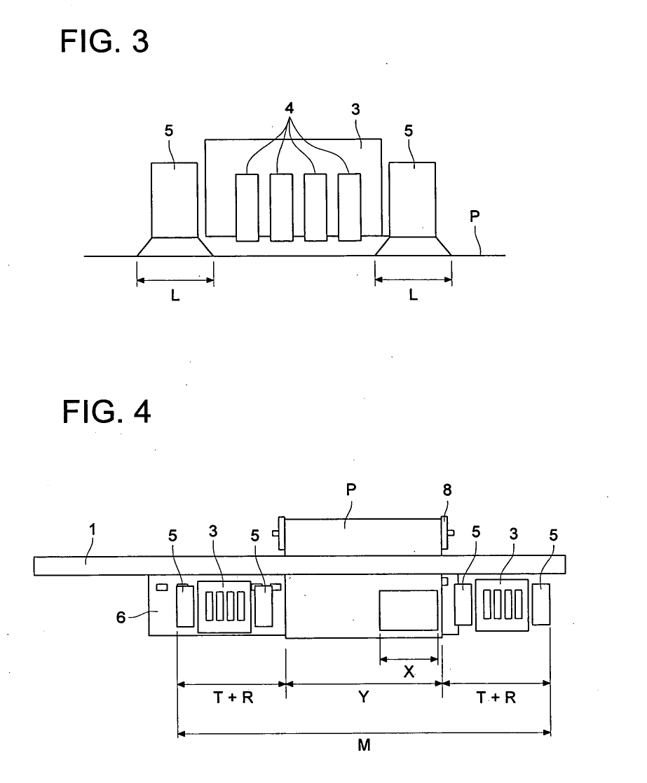

The non-volatile memory 18 is provided with an illumination range storage section 19 that stores the illumination range L along the main scanning direction A of the light emitted from the light source 5. As is shown in FIG. 3, the illumination range L is wider than the light emission window of the light source 5, and the illumination range L is stored in the illumination range storage section 19 considering this factor.

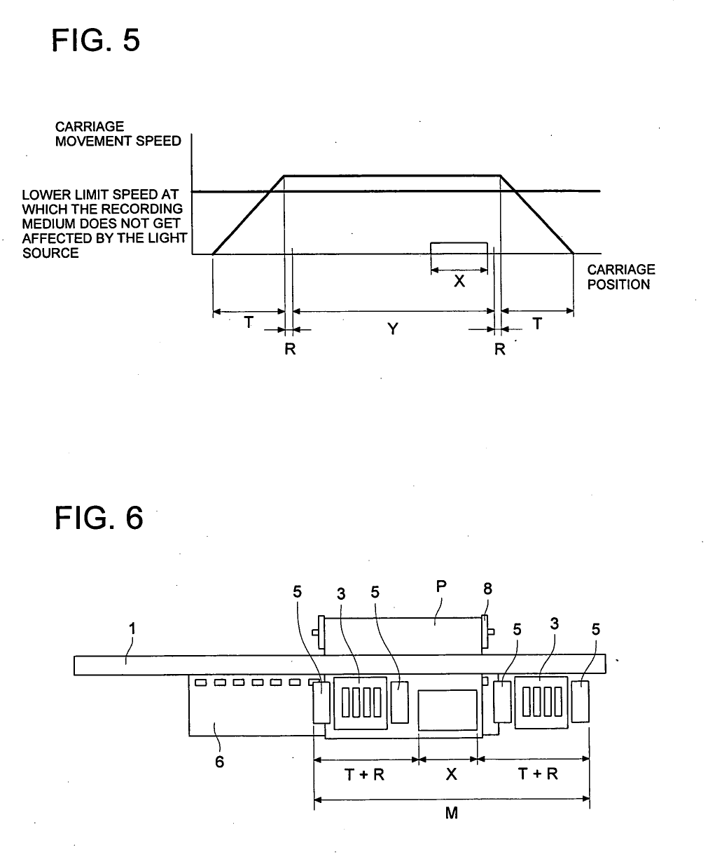

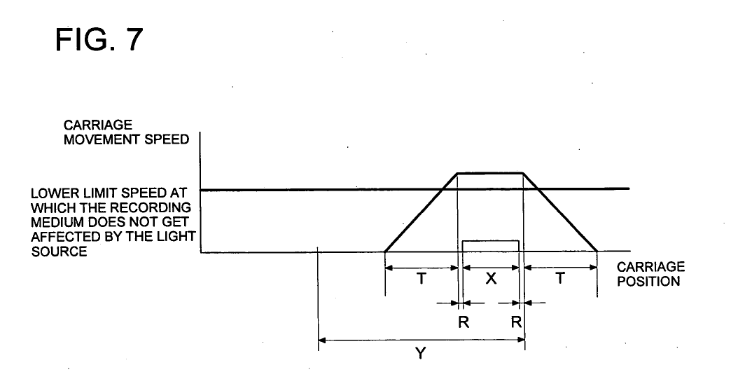

Further, the non-volatile memory 18 is provided with a recording medium width storage section 20 that stores the width of the recording medium detected by the recording medium width detection sensor 10, and as is shown in FIG. 4, the control section 13 moves the carriage 3 after it determines the carriage movement range M according to the width Y of the recording medium stored in the recording medium width storage section 20. Also, in the present preferred embodiment, as is shown in FIG. 4 and FIG. 5, the reciprocating movement is carried out by a distance equal to the sum of the width Y of the recording medium and the region T in which the carriage 3 carries out the returning operation as well as the spare region R.

Further, the non-volatile memory 18 is provided with the recording medium type storage section 21.

The control section 13 establishes correspondence between the type of the recording medium P detected by the recording medium weight detection sensor 11 and the type of recording medium P input using the operation panel 12 from among the types of recording medium P registered beforehand, and the recording medium type storage section 21 stores the type of the recording medium P after establishing correspondence between the registered type of the recording medium and the type of the recording medium either detected by the recording medium type detection sensor 11 or input from the operation panel 12.

In addition, the non-volatile memory 18 is provided with a lower limit speed storage section 22 that stores the lower limit speed of the movement of the carriage. The lower limit speed of the carriage is the limit of the speed of movement of the light source 5 associated with the movement of the carriage 3 during image recording so that the heat or the light emitted by the light source 5 does not have any effect other than that of hardening and fixing the ink on the recording medium P.

The control section 13 sets the lower limit speed in accordance with the type of the recording medium P stored in the recording medium type storage section 21, and the lower limit speed storage section 22 stores the lower limit speed set by the control section 13. In an example of establishing correspondence between the lower limit speed and the type of the recording medium, the control section 13 sets the lower limit speed to a higher speed value when the recording medium being used is weak towards heat, thus increasing the speed of carriage movement when it moves above the recording medium P thereby making the recording medium less liable to be affected by the heat from the light source.

Further, the control section 13 moves the carriage 3 above the recording medium P at a speed higher than the lower limit speed stored in the lower limit speed storage section 22. Therefore, as is shown in FIG. 5, when the carriage 3 is moving, the accelerating, decelerating, and stopping operations associated with the carriage return movement are not made above the recording medium P, and hence the recording medium P is prevented from being affected by heat or light.

Further, the control section 13 causes emission of the maximum amount of light that does not have any bad effect on the recording medium P when the carriage 3 is moved at the lower limit speed.

Further, the control section 13 is provided with the read only memory ROM 23 which stores various types of control processings executed by the control section 13.

Here, explanation is given about the accelerating and decelerating operations associated with the carriage 3 by the control section 13.

The image data which is inputted into the interface (I/F) 15 from the host computer 14 is converted into scan data being used in ink-jetting and buffer stored in the image processing section 16.

The control section 13 calculates a base position of edge of the recording medium (hereinafter called a start position). Furthermore the control section 13 also calculates a decelerating position of carriage 3 based on the width Y of the recording medium.

The control section 13 controls the carriage motor 2 so that the carriage 3 moves to the start position and controls a pulse control LSI (PCL) being not shown in the Figure so that the PCL sets a parameter including a moving direction, an acceleration rate, a predetermined speed and a the decelerating position associated with the movement of the carriage during inkjet-printing.

When a trigger signal of starting of inkjet-printing is outputted from the control section 13 the PCL controls the carriage motor 2 by driving pulse and the carriage motor 2 accelerates the carriage 3 to the determined speed according to the accelerating rate. When the carriage 3 reach the decelerating point PCL controls the carriage motor 2 so that the carriage motor 2 decelerates the carriage 3 according to the decelerating rate.

Here, explanation is given about the ink used in the present preferred embodiment.

The ink is of the light hardening type, and the ink in the present preferred embodiment is an ultraviolet ray hardening type ink that gets hardened upon irradiation with ultraviolet rays and forms the image.

The reaction of hardening of the ultraviolet ray hardening type of ink is called the ultraviolet ray hardening reaction which is the hardening of the ultraviolet ray hardening resin comprising pre-polymers, monomers, optical polymerization initiator, and additives in a very short time upon irradiation with light having a wavelength of 210-400 nm, that is, ultraviolet light. The ultraviolet ray hardening type of ink used should desirably be one that includes, among the constituents included in the ultraviolet ray hardening resins, at least polymerizing monomers, optical polymerization initiators, and coloring agents.

Further, ultraviolet ray hardening types of inks are broadly categorized into radical polymerization type of inks that include radical polymerization compounds as the polymerizing compounds and cation polymerization type inks that include cation polymerization type compounds.

The reaction of radical polymerization is the reaction of the optical polymerization initiator becoming a radical upon irradiation with ultraviolet rays, this radical approaches the polymeric double bonds (unsaturated radicals) of polymeric monomer whereby the double bonds become activated and get linked successively in the form of a chain, and since optical polymerization reaction is hindered by oxygen in the atmosphere, a relatively large quantity of ultraviolet ray irradiation becomes necessary in order to process in a short time the hardening of the surface of the ultraviolet ray hardening resin exposed to air. As a consequence, because an optical source unit with a high output power has to be installed, the entire apparatus becomes large in size and also its cost of manufacture becomes high.

On the other hand, in the case of the cation polymerization reaction, the radicals excited by ultraviolet light extract hydrogen from hydrogen release compounds and cause the release of hydrogen ions, and the polymerization reaction is started due to these hydrogen ions attacking the target. With this reaction, it is possible to harden the ink on the recording medium without being impeded by oxygen in the air during ultraviolet ray irradiation.

In view of this, since cation polymerization type of inks in the case where there is very little or no impediment to polymerization reaction by oxygen are superior in terms of functionality and general purpose use, cation polymerization type of inks are being used particularly in the present preferred embodiment.

Further, various types of widely known cation polymerization types of monomers can be used simultaneously as the cation polymerization type of monomers that are included in the cation polymerization type of inks. Examples of such compounds are epoxy compounds, vinyl ether compounds, and also oxetane compounds.

Next, the recording medium P used in the present preferred embodiment is described here.

Both absorbing type recording media and non-absorbing type recording media can be used as the recording medium P.

Transparent or opaque non-absorbing type plastic films used in the so-called soft packaging materials can be used as the non-absorbing type recording media.

Examples of absorbing type recording media are various types of paper such as the ordinary copying paper, recycled paper, glossy paper, etc., used with ink jet printers, various types of woven cloth, and various types of non-woven cloth.

Further, the shape of the recording medium P can be a roll, cut sheets, plates, etc.

In addition, the recording medium P used in the present preferred embodiment can also be well known opaque recording media such as various types of paper whose surfaces are coated with plastic, films containing pigments, foam films, etc.

Next, the effect of the present preferred embodiment is described here.

When the operation of the image recording apparatus is started and some specific image information is sent to the image processing section 16 of the main unit of the image recording apparatus from the host PC 10 via the interface I/F 11, the control section 13 not only makes the recording medium width detection sensor 10 detect the width Y of the recording medium but also makes the recording medium type detection sensor 11 detect the type of the recording medium P, and sets the lower limit speed of the carriage 3 in accordance with the type of the recording medium P.

Next, the control section 13 causes the recording medium P to be transported by the transportation mechanism 9 along the auxiliary scanning direction B.

Thereafter, the light source 5 is switched on, and simultaneously with emitting light towards the recording medium P, the carriage motor 2 is driven thereby making the carriage 3 move along the main scanning direction A above the recording medium P.

Next, while the carriage 3 is moving, the recording heads 4 are driven via the head driving section 17 based on the image information, and ink is made to be ejected from the nozzles towards the recording medium P. The ink ejected from the recording heads 4 are hardened quickly due to the light emitted from the light source 5 on the downstream side along the direction of advance of the carriage 3 and get fixed on the recording medium P.

At this time, as is shown in FIG. 4 and FIG. 5, the carriage 3 is moved in a reciprocating manner over the width Y of the recording medium, and control is carried out so that the return operation of the carriage 3 is not made in the state in which the illumination range L is above the recording medium P. Therefore, the carriage 3 moves always at a constant speed above the recording medium P and it is not possible for the recording medium P to be exposed to heat or light and to be affected badly by the heat or light when the return operation is being made. As a consequence, the recording medium P will not be affected by heat or light not only in the region X in which images are actually recorded but also in the regions where no images are recorded.

Further, since the carriage 3 is not moved by a distance more than is necessary, the movement region M of the carriage 3 is minimized and hence there is no extension of the scanning duration nor is there any reduction in the productivity.

Furthermore, since the carriage 3 is always moved at a speed higher than the lower limit speed above the recording medium P, even during image recording there is no possibility of the recording medium P being affected by heat and light more than is necessary. Also, when the carriage 3 is moved at the lower limit speed, it is possible to harden and fix definitely the ink onto the recording medium by emitting a maximum quantity of light that does not have bad effects on the recording medium P, and to enhance the image quality even in cases in which a recording medium that is poor in ink absorption ability is used.

Subsequently, the image is recorded on the recording medium P by the main unit of the image recording apparatus carrying out the above repeatedly.

In the above manner, in the ink jet recording apparatus according to the present invention, by controlling the movement of the carriage 3 in accordance with the width Y of the recording medium, and by carrying out control so that the return operations of the carriage are mode only when the illumination range L of the light emitted from the light source 5 has gone beyond the recording medium P, it is possible, without reducing the productivity, to obtain recorded images with a high resolution without the heat or light from the light source 5 having any bad effect on the recording medium P.

What is claimed is:

1. An ink jet recording apparatus comprising:
a carriage that can carry out reciprocating movement along the main scanning direction above the recording medium and that includes recording heads that eject light hardening type ink on to said recording medium and a light source that emits light on to said light hardening type ink ejected on to said recording medium; and
a control section that carries out control so that the carriage movement operation is made at a speed higher than a predetermined lower limit speed at the time when a illumination region of light emitted from said light source is above said recording medium.

2. The ink jet recording apparatus of claim 1, further comprising:
an illumination region storage section that stores said illumination region, wherein said control section controls the range of movement of said carriage based on said illumination region stored in said illumination region storage section.

3. The ink jet recording apparatus of claim 1, wherein the control section carries out control so that the return movement of said carriage is made after the range of illumination by the light beam emitted from said light source is beyond the recording medium.

4. The ink jet recording apparatus of claim 3, wherein said control section sets said lower limit speed in accordance with the type of said recording medium.

5. The ink jet recording apparatus of claim 1, wherein said light is ultraviolet light.

6. The ink jet recording apparatus of claim 1, wherein said light hardening type ink is an ultraviolet ray hardening ink of the cation polymerization type.

7. The ink jet recording apparatus of claim 1, further comprising:
a lower limit speed storage section that stores the lower limit speed of said carriage at the time when said illumination region is above said recording medium, wherein said control section controls the carriage so that the carriage movement operation is made at a speed higher than said lower limit speed stored in said lower limit speed storing section.
